(19) United States
(12) Patent Application Publication
(10) Pub. No.: US 2012/0038681 A1
(43) Pub. Date: Feb. 16, 2012

(54) TOUCH SCREEN

(76) Inventor: Ian Summers, Berkshire (GB)

(21) Appl. No.: 13/138,682

(22) PCT Filed: Mar. 24, 2010
(86) PCT No.: PCT/JP2010/055776

§ 371 Date: Oct. 21, 2011

(30) Foreign Application Priority Data
Mar. 25, 2009 (GB) 0905106.1

(51) Int. Cl. G06F 3/041; G09G 5/00

(52) U.S. Cl. 345/684; 345/173

(57) ABSTRACT

The present invention provides for a touch screen including control functionality through touch and movement of a digit of a user's hand over a defined path, and arranged to have the path selectively defined by the user's movement of a screen-engagement member and for example to define the location of such as a digit or stylus scroll bar, and to a hand-held electronic device employing the same over the surface of the screen.

### TECHNICAL FIELD

The present invention relates to a touch screen and in particular, but not exclusively, to a hand held electronic device employing such a screen, and also to a method for providing such a screen.

Priority is claimed on United Kingdom Patent Application No. 0905106.1, filed Mar. 25, 2009, the content of which is incorporated herein by reference.

### BACKGROUND ART

Touch screens, whether to be operated in combination with for example a stylus or a digit of a user's hand, have been widely adopted as combined display and user interface means for a wide variety of electronic devices offering a display function. Most noticeably, such screens have recently proved attractive for use on hand held devices such as mobile phone handsets and PDAs.

A user can interact with such a device simply through their manner of touching the screen, for example by way of a finger, and also through the sliding motion of the finger across the screen. The user's selection of, for example, icons displayed on the screen can then be made and “drag-and-drop” operations can be readily achieved through the sliding movement of the user's finger. Also, when moving through portions of text or an image part displayed on the screen, “touch and drag” functionality can also be provided. Yet further, it is possible to scroll the image being displayed, particularly when the size of the screen determines that only a small portion of the total image can be displayed at any one time. Scroll bars are then provided generally extending down the right hand side of the image region, for vertical movement of the image, and along the bottom region of the image region, so as to allow for horizontal movement of the image.

The choice of the use of “touch and drag” or use of the vertical/horizontal scroll bars is generally determined by the degree to which the user wishes to manipulate the displayed image. That is, if only a small movement of the image is required, it is likely that the user will seek to follow a “touch and drag” procedure, whereas if a large degree of movement is required through the displayed image/text then the scroll bars are likely to be employed.

However, known such screens and related devices can prove somewhat disadvantageously limited particularly when use of the scroll bars is required.

In particular, the use of the virtual scroll bars may require user manipulation/handling of the screen and/or device bearing the screen in a manner which is inappropriate, uncomfortable or generally troublesome for the user particularly when the device comprises a hand held device.

### DISCLOSURE OF INVENTION

The present invention seeks to provide a touch screen, and thus also a user device employing such a screen and, in particular, a hand-held user device employing such a screen, and having advantages over known such screens and devices.

According to a first aspect of the present invention, it is provided a touch screen including control functionality through touch and movement of a digit of a users hand over a defined path, and arranged to have the path selectively defined by the user's movement of a screen-engagement member over the surface of the screen.

In this manner, the actual region of the screen that is subsequently to serve as a contact region for control functionality etc can be readily determined and, as appropriate, selectively varied, by a user having regard to the manner in which the user engages, holds or otherwise manipulates the device.

Thus, particularly for a hand held device, since a user is most likely to hold the device in the most comfortable manner for operation at the time of selectively defining the path, subsequent control functionality by use, for example, of a digit of the user's hand is therefore likely also to occur in the most comfortable and likely ergonomic manner possible.

For example, if a user is most likely to hold a device in such a manner that his/her thumb is readily and comfortably positioned to move over a particular portion of the screen, it can be readily determined that the path which then will define the active region of the screen, can therefore likewise be defined in the region of the screen of which the users thumb will move during subsequent hand-held operation of the device.

Preferably, the path can be defined between respective start and stop end points of movement of the screen engagement member.

The path can comprise a definite defined path therebetween, or alternatively, can comprise, in more general terms, the general region found between the two points.

In one arrangement, the path can comprise the actual path of travel of the engagement member and so can have a width as determined by the width (as in contact with the screen) of the engagement member.

Further, at least one or more of the position, shape, size and general configuration of the path can be selectively determined by means of the screen engagement member.

In one arrangement, the control functionality can serve to change a characteristic of the display.

That is, the characteristic could comprise one or more of contrast and brightness and/or the characteristic could comprise movement of the display and/or its displayed items.

Advantageously, the control functionality can provide for scrolling of the display and the path can be represented in a scroll path format.

As required, the path can extend in an arcuate manner.

Yet further, the control functionality can serve to change the characteristic of a device on which the screen is provided. Such characteristics can of course comprise any required feature of operation of the device, for example, the output volume thereof.

The invention can advantageously provide for a plurality of selectively defined paths which, if required, can overlap.

As will be appreciated, the invention can provide for a hand held device including a screen as outlined in accordance with any one or more of the features noted above.

Such a hand held device can readily comprise a hand held communications device such as a mobile phone handset.

The screen engagement member can comprise any appropriate member for example, the digit of a user's hand, or of a specific contact device such as a stylus.

According to another aspect of the present invention, it is provided a method of providing a touch screen having control functionality through touch and movement of a digit of a users hand over a defined path, and including the step of a user selectively defining the path by movement of a screen engagement member over the surface of the screen.

Of course, it will be appreciated that the aforementioned method can be provided so as to allow for the provision of one or more of the further features of the touch screen as noted above.

As will therefore be appreciated from the foregoing, the invention proves particularly advantageous through the manner in which it can allow a user to define the shape and position of a scroll bar having regard to the actual manner in which, particularly, a hand held device is to be used.

Through employment of a user-defined scroll bar, it is no longer necessary for the user to employ right region and bottom region located scroll bars and the invention in particular can readily cater for both left and right-handed users.

As will be appreciated, not only can the path/shape of the scroll bar be readily defined by the user but also the start and end points thereof.

This can prove particularly advantageous in allowing a user to determine the degree of movement of the displayed image as a ratio of the degree of movement of the user's digit. Thus, even a relatively small movement of the user's digit over a portion of the screen which of course remains in easy reach, can translate into a large degree of movement of the image/text appearing on the screen.

### BRIEF DESCRIPTION OF THE DRAWINGS

The invention is described further hereinafter, by way of example only, with reference to the accompanying drawings in which:

FIG. 1 is a schematic plan view of a mobile communications handset employing a touch screen in accordance with the currently known art;

FIG. 2 is a schematic representation of a relationship between a complete text or image document and the portion thereof that can be displayed on a device such as that of FIG. 1 and also the present invention at any one time;

FIG. 3 is a schematic plan view of a mobile phone handset employing a screen embodying one aspect of the present invention;

FIG. 4 is a schematic plan view of a mobile phone handset employing a screen illustrating another example of the present invention; and

FIG. 5 is a schematic plan view of either of the device of FIGS. 3 and 4 and illustrating user definition of the scroll path such as that of FIG. 3.

### EXEMPLARY EMBODIMENT FOR CARRYING OUT THE INVENTION

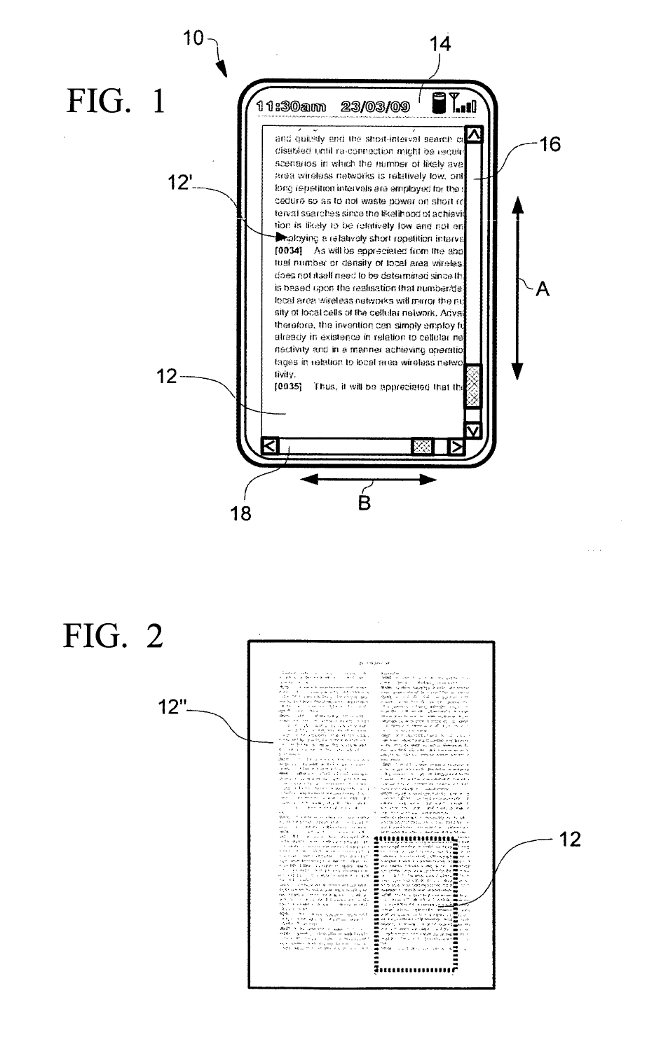

Turning first to FIG. 1, there is provided a schematic plan view of a mobile phone handset 10 employing a touch screen 12 as a user interface and which has portions 12 of an overall larger text document displayed thereon at any one time.

The screen 12 has a common functionality insofar as an upper display region 14 is provided for indicating, for example, the mode of operation, signal strength and current time and wherein the right and bottom border regions of the screen include scroll bars 16 and 18 which allow for movement of a displayed text portion 12′. The scroll bars are arranged to provide for vertical and horizontal movement of the displayed text image as indicated by arrows A and B, respectively.

As is common, the requirement for the scroll bars 16 and 18 arises insofar as the displayed text portion 12′ actually forms part of an overall larger text document 12″ such as that illustrated in FIG. 2.

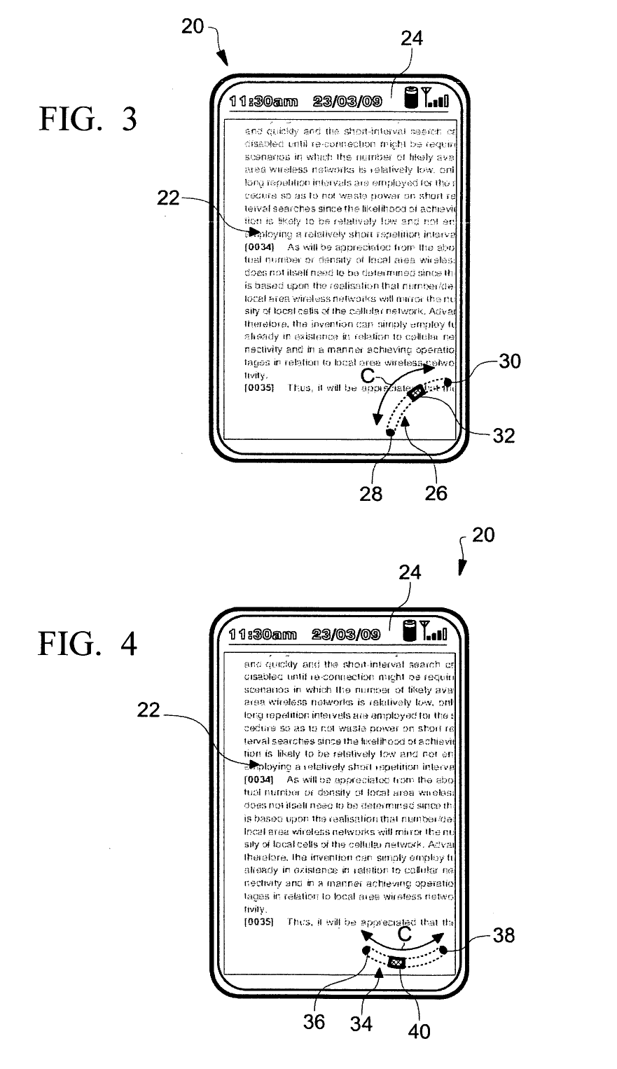

Turning now to FIGS. 3 and 4, there are provided schematic plan views of a mobile phone handset 20 employing different examples of the present invention.

As will be appreciated, each handset 20 is again arranged to display a portion 22 of an overall larger text/image document and again includes an upper display region for providing operating mode, signal strength and current time indications.

However, and importantly, it will be noted that the vertical and horizontal scroll bars indicated in the currently known handset of FIG. 1 are absent.

Rather, a smaller arcuate scroll bar is indicated in the lower region of the display 22 as discussed in further detail below.

Turning first to the example of FIG. 3, a small arcuate scroll bar 26 is displayed on the screen 22 extending in an arcuate manner between end points 28 and 30 and with a movement indicator “button” 32 provided on the path between those two points 28 and 30 defining the extent of the scroll bar.

In the illustrated example, the scroll bar is arranged so that by virtue of a users sliding touch of the portion of the screen indicated by the element 32, the displayed text/image on the screen 22 can move in a vertical direction. It should also be appreciated that such “sliding touch” need not serve to drag a “button” such as that the element 32, and such action at any point along the path between points 28 and 30 can serve to induce the required scrolling action for the displayed image. Elements such as the “button” can of course serve to provide for a ready reference indication of the portion of the larger overall image being displayed with regard to the top and bottom of that overall image.

Turning now to the example of FIG. 4, a similar short arcuate scroll bar 34 is illustrated extending between respective end points 36 and 38 and with a position indicating “button” element 40 provided on the path therebetween. Again, a user's touch and sliding motion over the element 40 and along the arcuate path scroll bar 34 serves to move the image/text displayed in the screen 22 in a horizontal direction.

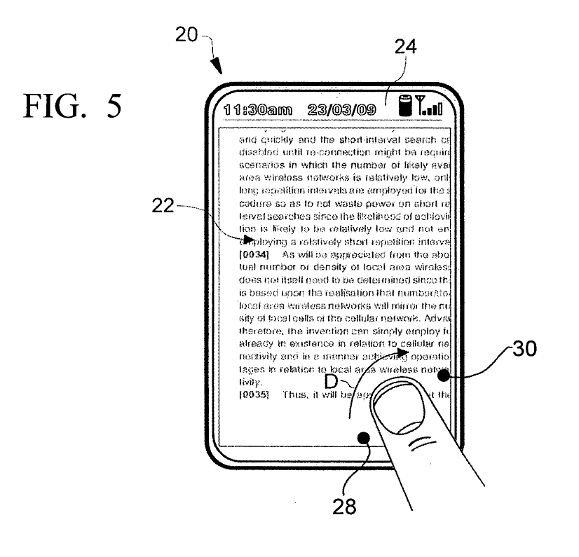

The relatively short scroll bars 26 and 34 illustrated in FIGS. 3 and 4 can prove not only advantageous insofar as the ratio of actual movement of the text/image on screen 22 to the actual movement of the indicator element 32 and 40 can be set at a high value, but the position and path of the scroll bars is such that they can be relatively accessed and “employed” by, for example, a user's thumb when holding the mobile phone handset 20. This highly ergonomic positioning of the scroll bars is achieved insofar as the position, extent and path of the scroll bar is in fact user-defined as will be described further with reference to FIG. 5.

Turning now to FIG. 5, there is illustrated in schematic form the user's manipulation of the mobile phone handset 20 of FIGS. 3 and 4 but in a manner in which the thumb of a user is employed to define the scroll bar 26 path illustrated in FIG. 3, and as such the end points 28 and 30 to be so defined are also illustrated.

It should of course be appreciated that any appropriate “capture” method can be employed in defining the scroll path. In particular, the end user's contact with the screen is most likely to create a contact surface area of which the centre can be calculated. The screen of course comprises an array of sensors each having its own appropriate x-y coordinates and so when the user makes contact with the screen various groups of such sensors will activate and so the screen, and/or the device employing the same, readily detects the location of the end user's point of contact. The activated sensors serve to map the end user's engagement with the screen. It will of course be appreciated that the sensors can employ any appropriate functionality such as inductive, capacitive or resistive fields as required.

As the end user's engagement member moves across the screen, it becomes possible to record the area of contact at a plurality of different time instances so as to calculate the path taken by reference to the centre point of each of those areas of contact. The path of such centre points serves to define the path that the engagement member of the end user has taken over the screen. If required, the x-y coordinates can then be averaged so as to provide a relatively smooth path, such as a smooth arc.

The actual width of the path which will serve to provide a future representation of the scroll path can be calculated in various ways. For example, the width between two edge points taken in relation to the surface area at one of the instances of measurement could be determined and such width then applied to all of the series of time instant readings so as to arrive at a scroll path of uniform width. Alternatively, separate readings between two edge points for each of the areas of contact determined of each of the previous time instances could be calculated and then averaged so as to arrive at the scroll path uniform in appearance.

Again, it should of course be appreciated that any appropriate position-capture steps can be taken in order to define the scroll path and the invention is no way limited to the examples discussed above.

As will be appreciated and with the mode of the mobile phone handset 20 set to “define scroll path”, a user's thumb can be moved into engagement with the screen 22 at a location to become one extreme end of the scroll path and move to the arcuate direction indicator by arrow D so as to arrive at a point that is required to be the furthest extent of the scroll bar and at which point the user's thumb then disengages from the surface of the screen 22.

By virtue of the movement of the thumb in this manner, it will be appreciated that the arcuate path or scroll bar 26 of FIG. 3 is defined and at a time when a user can choose to hold the mobile phone handset 20 in a particularly comfortable position.

Then, subsequent use of the actual scroll bar as indicated in FIG. 3 likewise occurs when the mobile phone handset 20 is held in that same a comfortable position.

Of course, it should be appreciated that since the path of the scroll bar is user defined it can be changed, modified and re-selected at any time and in accordance with a different user's requirements.

Indeed, if a personal profile is recorded on the handset, such a profile can also include a user's preferred scroll path which can prove particularly advantageous if a handset device might be both employed by right and left-handed users.

While a different scroll path is of course indicated for clarity purpose by way of FIG. 4, it will be appreciated that the screen 22 can readily be arranged so as to display both scroll bars which can overlap if required. This therefore allows for ready and comfortable movement of the displayed text/image in both vertical and horizontal directions. If overlapping in any way, the direction of movement of, for example, the user's finger will serve to dictate which scroll bar has prevalence at the point of cross-over.

Yet further, the scroll bar itself can be displayed in a “semi-transparent” manner so as to not obscure any text/image elements that might be located there under.

It should of course be appreciated that the invention is not restricted to the details of the foregoing example.

In particular, the scroll bars can be employed for the movement of any appropriate display item, whether text or otherwise and including for example cursors, screen icons and brightness/contrast/volume control displays. Also, the “ergonomic scroll bar” provided by way of the present invention can itself be a selectable feature for use, if required, in addition to “touch and drag” functionality and as an alternative to the standard vertical/horizontal scroll bars such that illustrated in FIG. 1.

It should be appreciated that the term screen is employed broadly within the present application to encompass any electronic arrangement/device offering some form of variable display characteristic and so includes interface devices such as touch pads offering display elements/functionality.

Also, insofar as the effective scroll path can be dimensioned and shaped as required by a user, the present invention can be readily adopted with irregular-shaped screens, software functions, and indeed objects upon which the screen might be provided. Further, the invention can also find ready use with non-rigid screens, for example those formed of flexible plastics/polymers such as those forming the basis of so-called electronic paper.

### INDUSTRIAL APPLICABILITY

The present invention can be applicable to a touch screen and, in particular, to a hand held electronic device employing such a screen, to facilitate the operation of the electronic device employing the touch screen in comfortable and ergonomic manner.

1. A touch screen including control functionality through touch and movement of a digit of a user's hand over a defined path and arranged to have said path selectively defined by the user's movement of a screen-engagement member over the surface of the screen.

2. A touch screen as claimed in claim 1, wherein said path is defined between respective start and stop end points of movement of the screen engagement member.

3. A touch screen as claimed in claim 1, wherein said path comprises the actual path of travel of said engagement member.

4. A touch screen as claimed in claim 1, wherein at least one or more of a position, shape, size and general configuration of the path is selectively determined by the screen engagement member.

5. A touch screen as claimed in claim 1, wherein the control functionality provides for scrolling of the display and said path can be represented in a scroll path format.

6. A touch screen as claimed in claim 1, wherein the path extends in an arcuate manner.

7. A touch screen as claimed in claim 1, including a plurality of selectively defined paths.

8. A touch screen as claimed in claim 1, wherein said control functionality is achieved through touch and movement of a user's hand over any portion of the defined path.

9. A hand held electronic device including a touch screen as claimed in claim 1.

10. A method of providing a touch screen having control functionality through touch and movement of a digit of a user's hand over a defined path, including a user selectively defining said path by movement of a screen engagement member over the surface of the screen.

11. (canceled)

12. A touch screen as claimed in claim 2, wherein said path comprises the actual path of travel of said engagement member.

13. A touch screen as claimed in claim 2, wherein at least one or more of a position, shape, size and general configuration of the path is selectively determined by the screen engagement member.

14. A touch screen as claimed in claim 3, wherein at least one or more of a position, shape, size and general configuration of the path is selectively determined by the screen engagement member.

15. A touch screen as claimed in claim 2, wherein the control functionality provides for scrolling of the display and said path can be represented in a scroll path format.

16. A touch screen as claimed in claim 3, wherein the control functionality provides for scrolling of the display and said path can be represented in a scroll path format.

17. A touch screen as claimed in claim 4, wherein the control functionality provides for scrolling of the display and said path can be represented in a scroll path format.

18. A touch screen as claimed in claim 2, wherein the path extends in an arcuate manner.

19. A touch screen as claimed in claim 3, wherein the path extends in an arcuate manner.

20. A touch screen as claimed in claim 4, wherein the path extends in an arcuate manner.

21. A touch screen as claimed in claim 5, wherein the path extends in an arcuate manner.
